(19) United States
(12) Patent Application Publication
(10) Pub. No.: US 2025/0367489 A1
(43) Pub. Date: Dec. 4, 2025

(54) Apparatus and Method for Sterilizing Waste and Producing a Biofuel Therefrom

(71) Applicant: Ronald Eugene Lukins, Ariel, WA (US)

(72) Inventor: Ronald Eugene Lukins, Ariel, WA (US)

(21) Appl. No.: 19/299,060

(22) Filed: Aug. 13, 2025

(51) Int. Cl. A62D 3/19; A62D 3/40; C10L 1/00

(52) U.S. Cl. CPC A62D 3/19; A62D 3/40; C10L 1/00

(57) ABSTRACT

The invention is an apparatus and method for sterilizing waste and, optionally, producing a biofuel. The method utilizes an apparatus for sterilizing waste by dehydrating it at ambient pressure or reduced pressure, maintaining the waste temperature above 0° C., collecting the distillate, applying a rough vacuum, sterilizing the waste by creating a plasma, and collecting the residual from the process. The rough vacuum must be between 133 Pa (1 torr) and 13 Pa (0.1 torr), and the plasma is a low-energy plasma having an energy of 50 to 300 Watts.

### BACKGROUND

The present disclosure relates generally to the treatment of waste. The invention is an apparatus and method for sterilizing waste and, optionally, producing a biofuel. The apparatus uses plasma for sterilization. Similar apparatuses have been used for surfaces and are disclosed in U.S. Pat. No. 5,683,540, which is incorporated herein by reference for all purposes. Waste is a necessary byproduct of life and civilization; the disclosed invention provides an apparatus and method for managing waste and producing a useful product.

The invention is useful for treating various types of waste, including liquid waste, sludge, semi-solid waste, and solid waste. It is a flexible design and readily scales up. The method combines water removal under rough vacuum with plasma sterilization, heat production, and the use of gas flow to move matter into different chambers as needed. Each subsystem can be tailored to the specific needs of each application. The invention properly processes waste to produce clean energy and generates substantial amounts of heat.

Current waste treatment systems are cumbersome, require large amounts of energy, and are expensive. Thus, there exists a need for a waste management system that is easily managed, uses minimal amounts of energy, and is cost-effective. Examples of the apparatus and method are discussed herein.

### SUMMARY

The method utilizes an apparatus for sterilizing waste by dehydrating it at ambient pressure or reduced pressure, maintaining the waste temperature above 0° C., collecting the distillate, applying a rough vacuum, sterilizing the waste by creating a plasma, and collecting the residual from the process. The rough vacuum must be between 133 Pa (1 torr) and 13 Pa (0.1 torr), and the plasma is a low-energy plasma having an energy of 50 to 300 Watts.

### BRIEF DESCRIPTION OF THE DRAWINGS

FIG. 1 is a flow diagram illustrating the steps involved in the batch process.

FIG. 2 is a flow diagram illustrating the steps involved in the continuous process.

FIG. 3 depicts the dehydration system with a hot air manifold.

FIG. 4 depicts the dehydration system with a solar reflector.

FIG. 5 depicts an electrically isolated impedance matching system.

FIG. 6 depicts a 1^{st} embodiment of the plasma treatment system.

FIG. 7 depicts a 2^{nd} embodiment of the plasma treatment system.

FIG. 8 depicts a 3^{rd} embodiment of the plasma treatment system with a matching impedance network and generator.

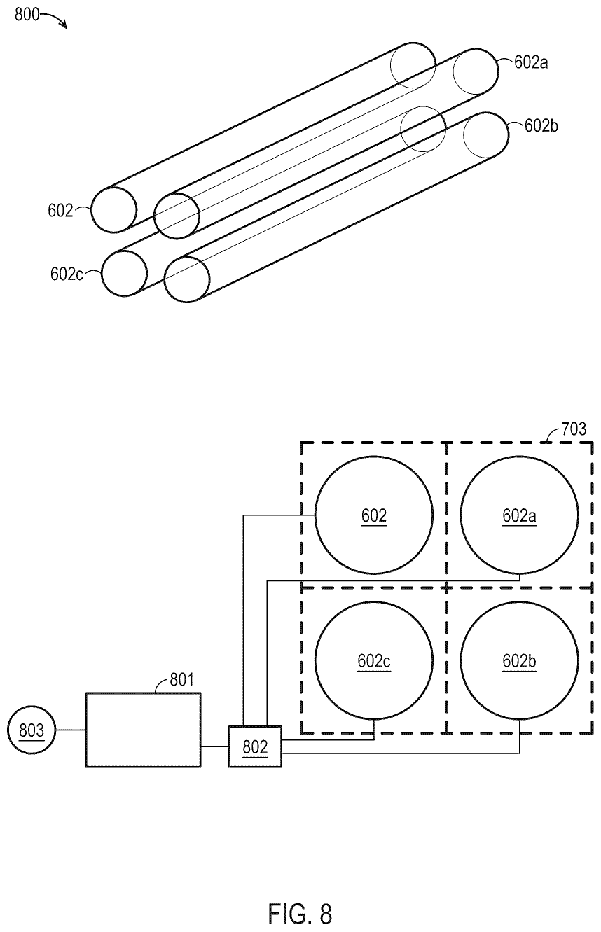

FIG. 9 depicts a 4^{th} embodiment of the system with electrically isolated inductors.

### DETAILED DESCRIPTION

The disclosed apparatus and method will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various apparatuses and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Low Mass Contaminated Water” means water, not sludge, that has bacteria and other unwanted microorganisms, and may contain some digestive matter.

### Apparatus and Method for Sterilizing Waste and Producing a Biofuel Therefrom

The critical feature of the system is the dehydration of waste, followed by treatment with plasma. Dehydration can be run at 1 atmosphere (˜101 Pa or 760 torr). Preferably under rough vacuum at 133 Pa (1 torr) to 13 Pa (0.1 torr). Another critical feature is the application of low-energy plasma under rough vacuum. The energy of the plasma should be less than 300 Watts, but preferably between 50 and 300 Watts. The method can be run under air or oxygen.

The apparatus operates the method by being fed a quantity of waste, dehydrating the waste, collecting the distillate, applying a rough vacuum, and then sterilizing the waste using plasma. The output of the process can be used as an odorless, clean-burning biofuel or burned for process heat. The process can be a batch process or a continuous process. Multiple systems can be run in series or parallel. The entire process can be run in one chamber, or each step can occur in separate chambers. The apparatus's footprint can be adjusted to match the quantity of waste. It can be a permanent installation or a mobile system that can be transported by truck or van from site to site.

### I. Method for Sterilizing Waste and Producing a Biofuel Therefrom

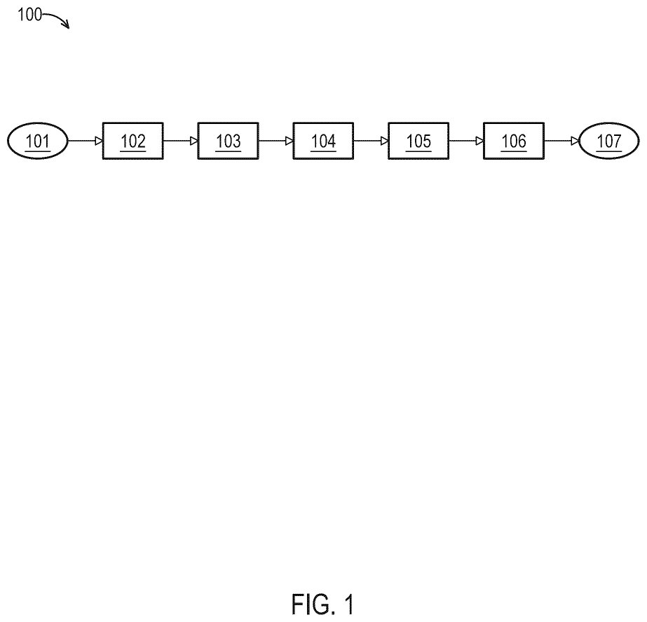

Referring to FIG. 1, a quantity of waste, 101, is provided for treatment. The waste comprises: (1) bio-organic matter with nonlimiting examples including, biproducts of fully or partial digestion such as proteins, amino acids, digestive bio-matter such as urea, bilirubin, and other bio-matter associated with digestion; bacteria, and possibly parasites; excrement from living creatures, and significant amounts of water; (2) hydrocarbons with nonlimiting examples such as alkanes, alkenes, alkynes, alcohols, ketones, ethers, esters, organic acids, cycloaliphatic, and aromatic compounds; (3) food matter with nonlimiting examples such as plant and animal matter suitable for consumption or unsuitable for consumption; and (4) trace inorganics and minerals. The waste can be fed into the process continuously or in batches.

The waste is then dehydrated, 102. Bulk water is removed by mixing the sample at ambient temperature, and heated air is applied just above room temperature, initiating water evaporation. Alternatively, the bulk water can be removed using a non-vacuum system that uses both heat and a mechanical means to mix the matter, exposing the entire volume of the waste to heat and the ambient atmosphere; or a partial vacuum and hot air can be used to increase the rate of removal of the bulk of the water.

Additionally, vacuum fractional distillation can be used to remove water and organic matter having distinctly different boiling or reaction temperatures. The reactive environment created during fractional distillation provides the heat energy for boiling under vacuum; however, the reactivity of the waste being processed also contributes to heating the matter to be processed through exothermic reaction processes.

The process of using a vacuum to remove water, however, has a cooling effect on the matter being processed, and under certain conditions, can cause the material being processed to freeze. As a result, the initial temperature of the material to be processed, the rate of creating a vacuum, and the vacuum levels must be controlled and monitored. The water and fractionated liquids are removed from the process by collection in cold traps, or water vapor can be vented to the air.

After sufficient water is removed, 102, the system is pumped down to a rough vacuum, and oxygen-based plasma is applied to the dehydrated waste, 103. The plasma heats the material, whereby remaining organic liquids, as well as other organics, boil off or are otherwise oxidized by the oxygen plasma. The organics are destroyed by the plasma, converted into simple gases, and trapped for collection if so desired. The reaction of organics with oxygen plasma is exothermic, generating energy that drives the process further. After this step, the material is dry and sterile, 104.

The continued reaction of the remaining material, 105, with the plasma leads to very high temperatures. The material turns visibly red hot at a temperature of about 400° C. (750° F.). Once the material is completely processed, it can be removed and burned in an air-burning furnace without foul smells from animal or human waste, 106, or collected and used as a biofuel, 107.

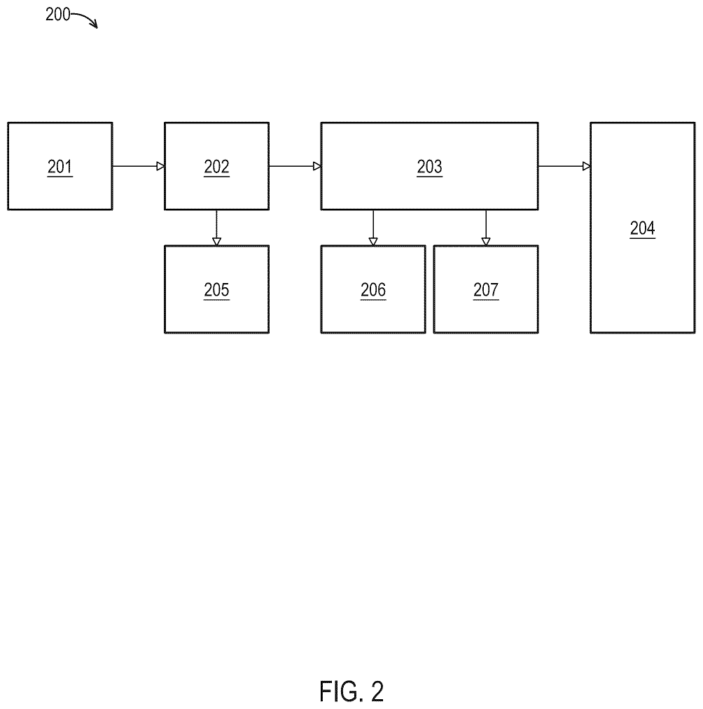

FIG. 2 discloses a continuous process for the sterilization of waste and the production of a biofuel 200. A quantity of waste is continuously fed 201 into the process, 200. The first step is bulk water removal, 202, and the evaporated water is collected in a cold trap 205. In the second step, the bulk dehydrated waste is moved to the reaction chamber, 203. In the reaction chamber, 203, additional liquids, with nonlimiting examples such as low-mass contaminated water, 206, and residual digestive matter not converted to heat, are removed and collected in cold traps, 206 and 207, respectively. In the third step, either simultaneously with step 203 or sequentially, oxygen plasma is applied to the dehydrated waste. Additionally, the temperature and pressure of the reaction chamber, 203, can be adjusted as discussed above to facilitate the dehydration of the waste and sterilize it. The material that then exits the reaction chamber is a clean biofuel, 204.

A batch process is the preferred embodiment for the method. A quantity of waste is introduced to the reaction chamber. The chamber is sealed, and the reaction is conducted in air. The quantity of waste is agitated to maximize exposure of the surface to the chamber environment. The liquids in the waste are removed by fractional distillation. Distillation begins at approximately 101 kPa (760 torr or 1 atm), and the sample is heated to 100-140° C. To facilitate fractional distillation, the pressure and temperature are lowered to approximately 1 kPa (about 10 torr) and 11 to 30° C. The distilled liquids are collected in cold traps. The collected liquid can be further treated as greywater or blackwater. Once the waste has been dehydrated, the pressure is returned to approximately 101 kPa, and oxygen plasma is applied to the dehydrated waste, thereby sterilizing the waste. Further application of the oxygen plasma increases the temperature to about 400° C. The waste can be further processed until it is all consumed or cooled and removed for use as a biofuel. In another embodiment, the process is conducted under an oxygen atmosphere.

### II. Apparatus for Sterilizing Waste and Producing a Biofuel Therefrom

The apparatus comprises a dehydration system, an impedance matching system, and a plasma and treatment system. Subsystems include cold traps to collect the distillate. Agitators are used to turn over the material, providing a fresh surface to the treatment environment. A vacuum pump to provide a rough vacuum. A generator to supply electrical power and, lastly, a heat source.

### A. Dehydration System

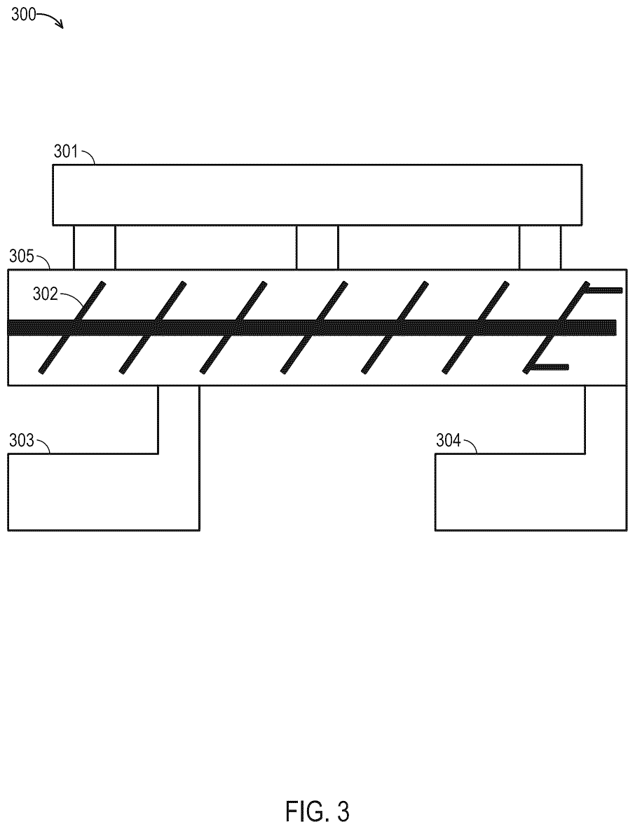

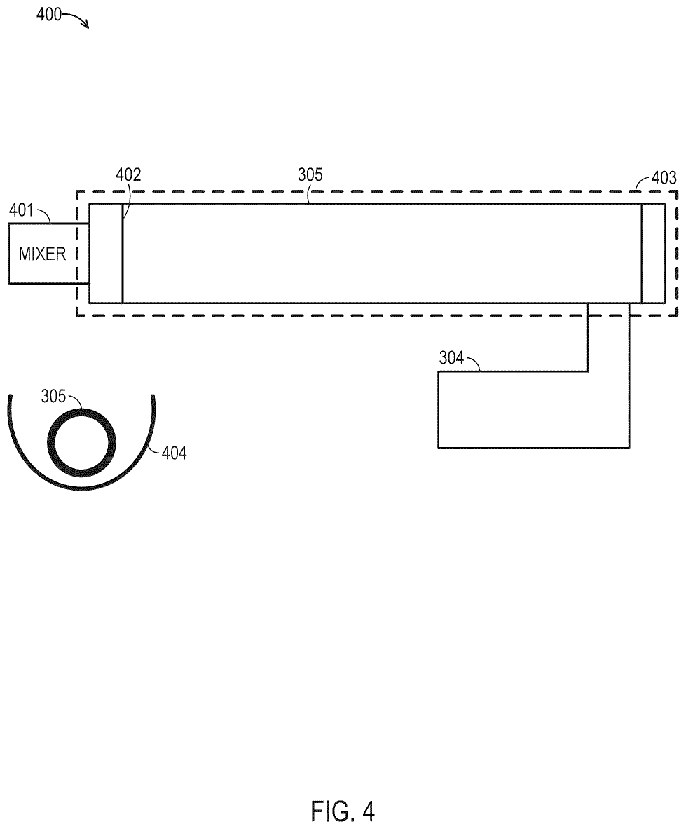

FIG. 3 describes a first embodiment of the bulk dehydration system, 300. The bulk dehydration system, 300, comprises a hot air manifold, 301, a mixer, 302, a material feed supply, 303, a holding tank for dehydrated material, 304, and the dehydration chamber, 305. FIG. 4 depicts a second embodiment of the dehydration system, 400. In this embodiment, solar energy, via a parabolic reflector, 404, is used to heat the material. The second embodiment further comprises a drive shaft, 401, for the mixer 302, and a plunger, 402.

### B. Electrically Isolated Impedance Matching System

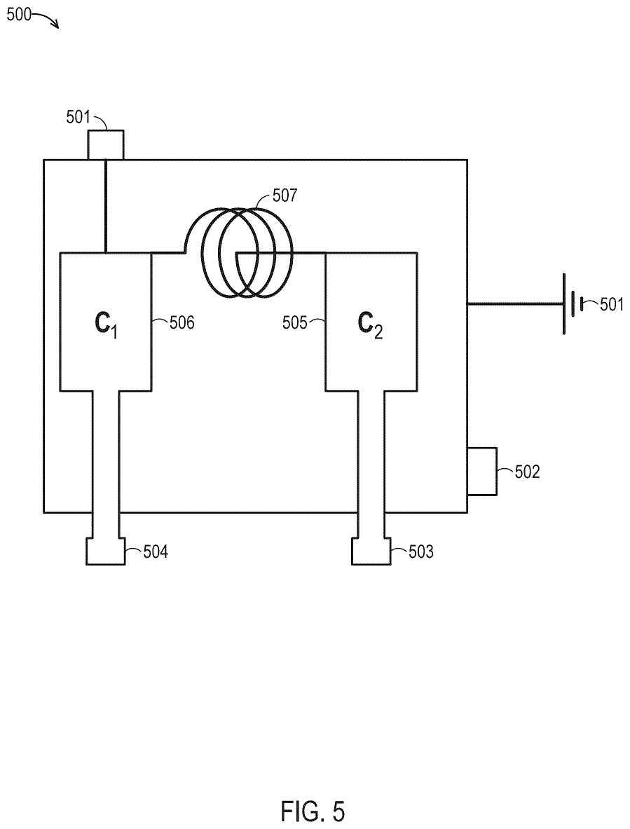

FIG. 5 depicts an electrically isolated impedance matching system, 500. The impedance matching system, 500, comprises a power input, 501, and an electrical connection to the plasma coil, 502. In addition, the impedance matching system further comprises variable capacitors 503 and 504, as well as cold traps 505 and 506, along with an inductor 507.

### C. Plasma Treatment System

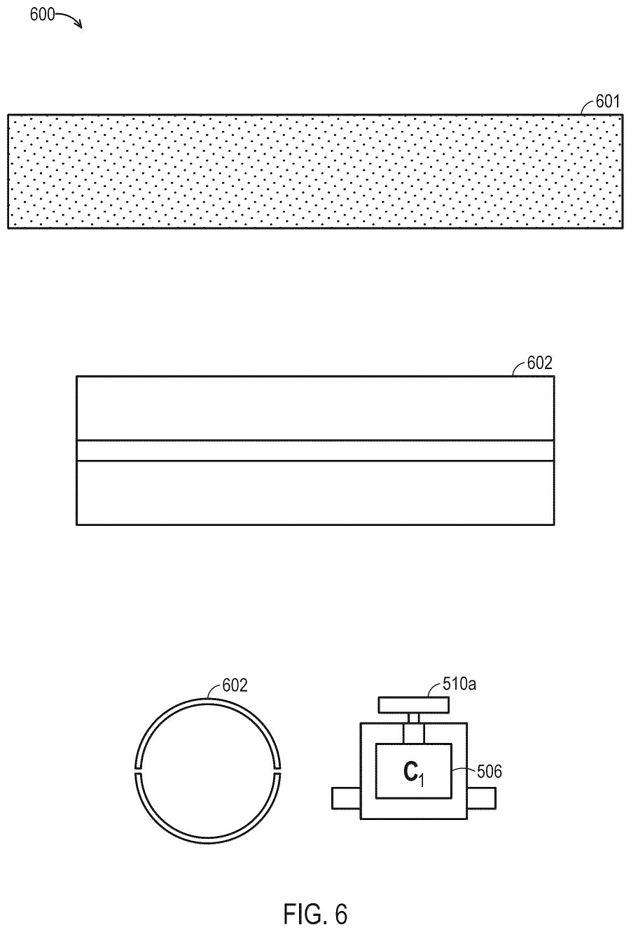

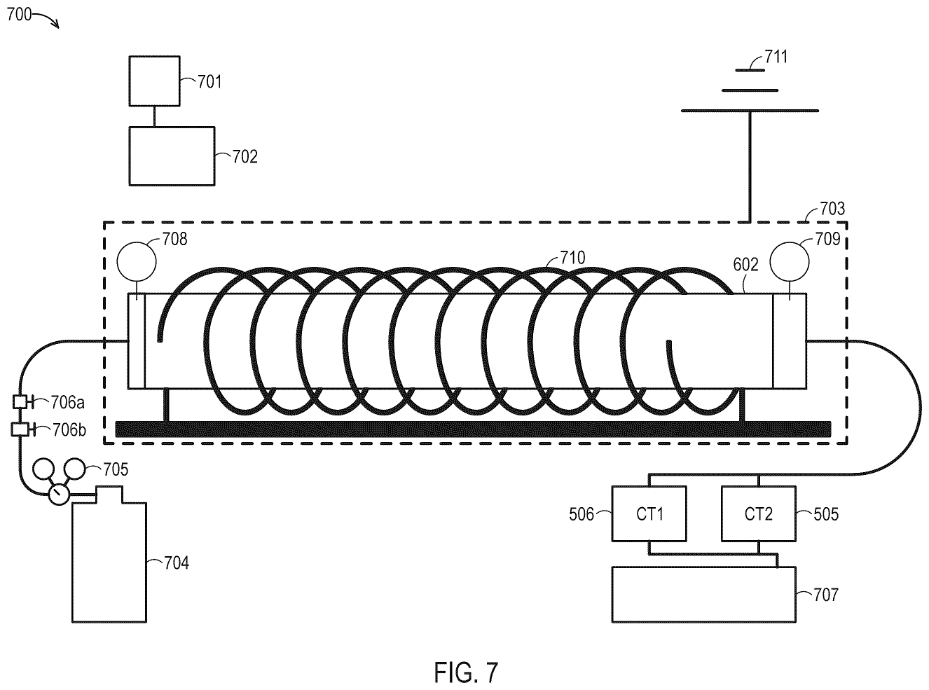

FIGS. 6 and 7 illustrate the components of the plasma treatment systems 600 and 700, respectively. The plasma treatment system comprises a reaction chamber, 602, defined by a cylindrical space. Electrodes 601 are connected to the reaction chamber 602 and comprise a metalized polymer, which can optionally be insulated and protected from the environment. The plasma treatment system is powered by a generator connected to the impedance matching system 500, which is connected to the plasma treatment system via the solenoid electrode 710. The plasma treatment system further comprises a ground, 711, a Faraday cage, 703, an oxygen tank 704, a regulator, 705, fixed rate valves, 706a and b, and a vacuum pump connected to cold traps 1 and 2, 505, 506 respectively, and vacuum pressure gauges, 708 and 709.

In one embodiment, the generator 701 is a 13.56 MHz generator. Element 702 is a 13.56 impedance matching network. The Faraday 710 cage confines essentially all the 13.56 MHz radiation to within the cage and prevents electrical sources outside the cage from affecting the electrical system within.

In another embodiment, the plasma treatment systems 600 and 700 comprise multiple reaction chambers 602, 602a-c, and 800. The embodiment includes a 13.56 MHZ matching network, 801, used in conjunction with the 13.56 MHZ generator, 803, and plasma electrode, 601. The matching network, 801, component manages the impedance values. For a system that uses multiple reaction chambers 602, the chambers can be arranged in parallel 602 and 602a-c, or in series (not shown). A switch, 802, is used to change the electrical power to the different chambers, 602 and 602a-c.

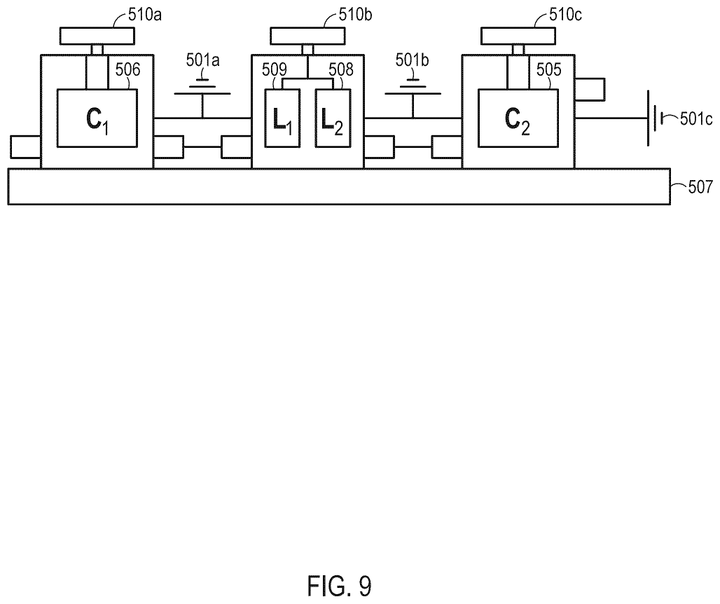

FIG. 9 depicts another embodiment comprising: power inputs, 501a-c, cold traps, 505 and 506, a ground plane and mechanical foundation, 507, where all the matching network, 801, elements are electrically attached. In this embodiment, all matching network components, 801, are located within their own Faraday cage, which means they are electrically grounded and have electrically isolated shields. This embodiment further comprises electrically isolated inductors 508 and 509, for which the inductor values can be changed using control knobs 510a-c.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Having set forth the particulars of the invention herein, we claim:

1. A method for sterilizing waste comprising:
a. providing a quantity of waste;
b. dehydrating said waste;
c. collecting the distillate;
d. applying a vacuum;
e. sterilizing the waste by creating a plasma; and
f. collecting the residual from the process.

2. The method of claim 1, where the waste is a solid, semi-solid, sludge, or liquid.

3. The method of claim 1, where the waste is heated during dehydration; where the heat is supplied by at least one of the following:
a. where the heat is applied to the waste using hot air from a manifold;
b. where the heat is applied to the waste using a solar reflector; or
c. where the heat applied is recycled heat from the process.

4. The method of claim 3, where the dehydration is done under a vacuum of less than 101 Pa.

5. The method of claim 1, where the distillate is collected in at least one cold trap.

6. The method of claim 1, where the temperature of the waste is kept above 0° C.

7. The method of claim 4, where the temperature of the waste is kept above 0° C.

8. The method of claim 4, where the distillate is collected in at least one cold trap.

9. The method of claim 1, where the vacuum is a rough vacuum.

10. The method of claim 9, where the vacuum is between 133 and 13 Pa.

11. The method of claim 1, where the plasma is a low-energy plasma.

12. The method of claim 11, where the plasma is between 50 and 300 Watts.

13. The method of claim 1, where the residual is a biofuel.

14. A method for sterilizing waste comprising:
a. providing a quantity of waste, where the quantity of waste can be at least one of the following: solid, semi-solid, sludge, or liquid;
b. dehydrating said waste, where dehydration is done at ambient pressure; 101 Pa, or less than 101 Pa;
c. heating the waste;
d. where dehydration occurs at any temperature above 0° C.;
e. collecting the distillate in at least one cold trap;
f. applying a vacuum, where the vacuum is between 133 and 13 Pa;
g. sterilizing the waste by creating a low-energy plasma of 50 to 100 Watts;
h. where the method is run under air or oxygen;
i. collecting the residual, where the residual is a biofuel.

15. The method of claim 14, where the waste is heated during the dehydration step, where the heat source can be at least one of the following:
a. hot air,
b. concentrated sunlight from a solar reflector, or
c. recycled heat from the process.

16. Where the method of claim 15 is a batch process or a continuous process.

17. An apparatus for sterilizing waste comprising:
a. at least one hollow chamber that can be sealed and unsealed;
b. a means to supply waste to the chamber;
c. a means to apply heat;
d. a means to create a vacuum;
e. a means to convey waste into and out of the hollow chamber;
f. a means to create a plasma;
g. at least one Faraday cage; and
h. at least one cold trap.

18. The apparatus of claim 1 further comprises a plurality of chambers placed in sequence or in parallel.

19. The apparatus of claim 1, where the heating means can be at least one of the following: a hot air manifold or a solar reflector.

20. The apparatus of claim 1, where the conveying means can be a screw, a plunger, or air.
